(19) United States
(12) Patent Application Publication
(10) Pub. No.: US 2026/0138839 A1
(43) Pub. Date: May 21, 2026

(54) LOADING SYSTEM FOR LOADING A TRANSPORT UNIT

(71) Applicant: Simec Systems Oy, Oitti (FI)

(72) Inventors: Simo AITTO-OJA, Oitti (FI); Ville VOLANEN, Oitti (FI)

(21) Appl. No.: 18/950,614

(22) Filed: Nov. 18, 2024

(51) Int. Cl. B65G 67/04; B65G 13/00; B65G 41/00; B65G 69/28

(52) U.S. Cl. CPC B65G 67/04; B65G 13/00; B65G 41/003; B65G 69/28

(57) ABSTRACT

The application relates to a loading system (100) for loading a transport unit (104). The loading system comprises a chassis (112), a roller bed (120) mounted on the chassis, and a mount mechanism (114) to mount the chassis on a loading dock (116). The chassis comprises a lateral position mechanism (282) configured to position the roller bed laterally with respect to the loading dock. The roller bed comprises rollers (224) configured to roll the roller bed for-wards and backwards (FW, BW) with respect to the chassis. The roller bed is configured to carry a load (102) to be loaded to the transport unit. The loading system further comprises a drive mechanism (234) that is configured to drive the roller bed forwards and backwards with respect to the chassis and mounted beside the chassis to enable a fixed mounting of the chassis to the loading dock by means of the mount mechanism so that an elevation of the chassis is permanent with respect to the loading dock.

### TECHNICAL FIELD

The application relates generally to a loading system for loading a transport unit.

### BACKGROUND

A known one-shot loading system for loading palletized or non-palletized goods to a cargo space of a transport container comprises a chassis and a carriage mounted on the chassis so that the carriage can move along the chassis to the transport container and back. The known loading system further comprises a buffer structure, which comprises a buffer beam and a massive lifting gate structure to lift and to lower the buffer beam vertically, at a loading end of the chassis.

The goods are loaded successively on the carriage, which is then driven through the lifting gate structure, when the buffer beam has been lifted up, to the transport container. When the goods are inside the transport container, the buffer beam is lowered in the lifting gate structure to contact and to support an end of successively loaded goods. The conveyor is driven out from under the goods while the end of the goods is supported by the lowered buffer beam as long as the convey-or is under the goods.

When the conveyor has been driven out from the transport container and the goods are in the transport unit, the buffer beam is lifted by the lifting gate structure and the loading system is again ready for a next loading operation.

### SUMMARY

One object of the invention is to withdraw the drawbacks of known solutions and to provide a retrofit loading system, which facilitates and enhances a loading of transport unit in existing loading docks (platforms) cost-effectively without any massive changes in structures of the loading docks.

One object of the invention is fulfilled by providing the loading system and loading method according to the independent claims.

Embodiments of the invention are disclosed in the claims.

One loading system for loading a transport unit comprises a chassis, a roller bed mounted on the chassis, and a mount mechanism to mount the chassis on a loading dock. The chassis comprises a lateral position mechanism configured to position the roller bed laterally with respect to the loading dock. The roller bed comprises rollers configured to roll the roller bed forwards and backwards with respect to the chassis. The roller bed is configured to carry a load to be loaded to the transport unit. The loading system further comprises a drive mechanism that is configured to drive the roller bed forwards and backwards with respect to the chassis and mounted beside the chassis to enable a fixed mounting of the chassis to the loading dock by means of the mount mechanism so that an elevation of the chassis is permanent with respect to the loading dock.

One loading method for loading a transport unit by means of the previous loading system comprises a following step of establishing, by a mount mechanism, a permanent elevation of a chassis of a transport unit with respect to a loading dock. The loading method further comprises a following step of mounting, by the mount mechanism, a chassis of a transport system on a loading dock. The loading method further comprises a following step of positioning, by a lateral position mechanism, a roller bed of the transport system laterally with respect to the loading dock below the chassis. The loading method further comprises a following step of driving, by a driving mechanism, the roller bed carrying forwards with respect to the chassis when a load is loaded into the transport unit. The loading method further comprises a following step of driving, by the driving mechanism, the roller bed backwards with respect to the chassis when the roller bed is retracted from under the load in the transport unit. The roller bed comprises rollers that rolls the roller bed forwards and backwards with respect to the chassis and the drive mechanism is mounted beside the chassis to enable a fixed mounting of the chassis to the loading dock so that the elevation of the chassis is permanent.

### BRIEF DESCRIPTION OF THE FIGURES

The exemplary embodiments of the invention are explained with reference to the accompanying figures:

FIG. 1 presents a loading system mounted on a loading dock

FIG. 2 presents details of the loading system

FIG. 3 presents details of a chassis and its partial cross-section

FIG. 4 presents the loading system when a roller bed is loaded with goods and the roller bed has been positioned with respect to a transport unit

FIG. 5 presents the loading system when a buffer device has been lowered to buffer the load for a retraction of the roller bed from the transport unit

FIG. 6 presents the loading system when the roller bed has been retracted from the transport unit and the buffer device has been lifted

### DETAILED DESCRIPTION OF THE FIGURES

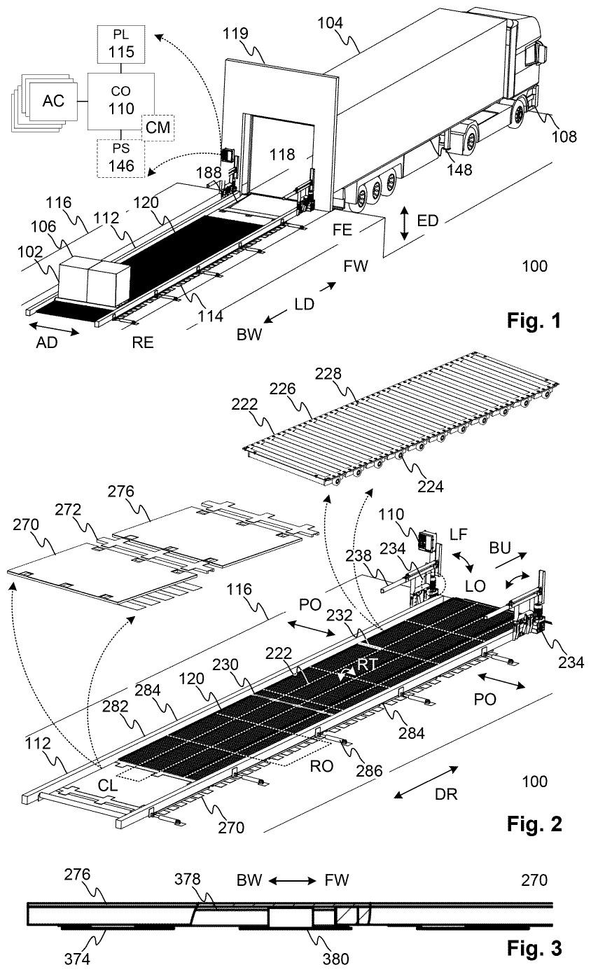

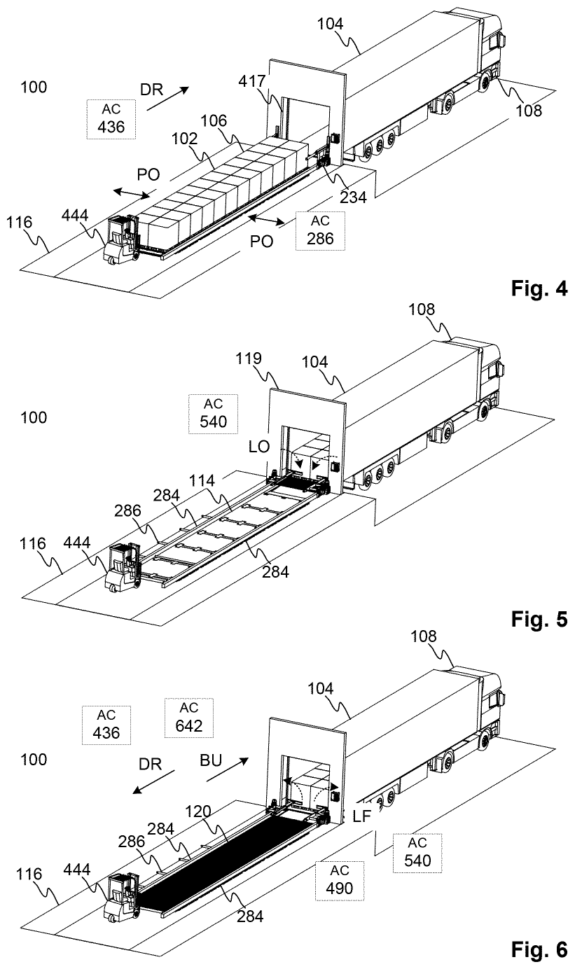

FIG. 1-6 present a retrofit loading system 100 for loading a palletized and non-palletized load 102 into a transport unit 104 in a one-shot loading operation and its details. The load 102 comprises at least one pallet, e.g., one, two, four, six, or more pallets and at least one good 106, e.g., one, two, three, four, or more goods, on each pallet, when the load 102 is palletized. The load 102 alternatively comprises at least one good 106, when the load 102 is non-palletized according to the figures.

The transport unit 104 comprises an unmodified cargo space, e.g., an open cargo space (transport platform) of a truck 108 or a trailer, closed cargo space (container) of the truck 108 according to the figures, closed cargo space of the trailer, or a freight container.

The loading system 100 comprises a controller 110 that is configured to control operating parts of the loading system 100, e.g., parts 115, 120, 146, 188, 234, 238, 282, 286, 436, 490, 540, 642, and a buffer beam, if such exists, to operate the loading system 100.

The controller 110 comprises a processor configured to carry out operator-initiated instructions, computer program (application, software)-initiated instructions, or both and to process information to run computer programs CM. The processor comprises at least one processor, e.g., one, two, three, four, or more processors.

The controller 110 further comprises a memory, which is not presented in the figures, that is configured to store and to maintain information. The information comprises, e.g., instructions, computer programs CM, and information files. The memory comprises at least one memory, e.g., one, two, three, four, or more memories.

The processor together with the memory, which stores a computer program CM to operate the loading system 100, are configured to control the loading system 100 and its parts 115, 120, 146, 188, 234, 238, 282, 286, 436, 490, 540, 642 so that the loading system 100 carries out the operations that have been explained previously and later on.

The loading system 100 further comprises a chassis 112 that is configured to establish a support structure, a mounting structure, and a protective structure for the parts 120, 234, 238, 282, 286, 436, 540, 642 of the loading system 100.

The chassis 112 comprises a modular mount mechanism 114 that is configured to mount the loading system 100, i.e., the chassis 112, fixedly on an existing loading dock (platform) 116 with a loading door 417 in a wall structure 119 of the loading dock 116. The loading dock 116 operates as a mounting platform (surface) for the retrofit loading system 100. The chassis 112 is mounted on the loading dock 116 so that its elevation is permanent with respect to the loading dock 116. The chassis 112 lacks legs and a possibility to adapt an elevation of the chassis 112 to match (level) the chassis 112 and a floor (bottom surface) 118 of the transport unit 104 by means of the legs.

The loading dock 116 comprises an existing or retrofit loading ramp 188 mounted in a rear end RE of the loading dock 116, which is configured to be lifted or lower in an elevation direction ED to adapt an inclination of the loading ramp 188 so that an edge of the loading ramp 188 match to the floor 118 of the transport unit 104 according to the figures, whereupon it is possible to load the load 102 in the transport unit 104 by means of the loading system 100.

The loading dock 116 further comprises a ramp actuator 490, e.g., a hydraulic actuator, mounted in the loading ramp 188. The ramp actuator 540 is configured to lift and to lower the loading ramp 188 on the grounds of control commands from the controller 110, when the loading system 100 is connected with the ramp actuator 490.

The mount mechanism 114 comprises at least one mount module 270, e.g., one, two, four, six, or more mount modules 270, which is configured to be mounted directly on a surface of the loading dock 116 by means of, e.g., a glue, screw, or other suitable attachment. The chassis 112 is formed by attaching mount modules 270 successively in the longitudinal direction LD to the loading dock 116 and by connecting the mount modules 270 by means of connection elements 272 between the successive mount modules 270 so that the mount modules 270 and the connection elements 272 form a uniform upper surface for the chassis 112.

Each mount module 270 comprises a mount plate (panel) 374, which is configured to be attached against the loading dock 116 so that its lower surface 374 contacts with the surface of the loading dock 116, and a top plate 276, which is configured to form a part of the upper surface of the chassis 112, on the mount plate 374.

Each mount module 270 further comprises shafts (axles) 378, which are mounted on a lower surface of the top plate 374 and between the mount and top plates 276, 374 in the longitudinal direction LD. Each shaft 378 comprises at least one lateral roller (bushing) 380, e.g., one, two, three, four, or more lateral rollers, on each shaft 378 so that the shaft 378 is installed through lateral roller 380. Each lateral roller 380 between the mount and top plates 276, 374 is configured to roll (rotate) around the shaft 378, whereupon the top plate 276 is able to move in a lateral direction AD with respect to the mount plate 374, and to move forwards FW and backwards BW along the shaft 374 in the longitudinal direction LD, whereupon the top plate 276 is able to rotate diagonally with respect to the mount plate 374.

Each mount module 270 alternatively comprises a mount plate 374, which is configured to be attached against the loading dock 116 so that its lower surface 374 is towards the surface of the loading dock 116 and its upper surface is configured to form a part of the upper surface of the chassis 112.

When each mount plate 270 comprises the alternative simple structure, the mount mechanism 114 further comprises at least one slide plate (panel), e.g., one, two, four, six, or more slide plates, which is not presented in the figures and which is installed between the loading dock 116 and the at least one mount plate 270. Each slide plate comprises a synthetic ice, i.e., a so-called plastic ice, which has been manufactured by hot-pressed polyethene that may be self-lubricating.

Each slide plate is configured to be mounted directly on the surface of the loading dock 116 by means of, e.g., a glue, screw, or other suitable attachment. The chassis 112 is formed by attaching a slide plate to the loading dock 116, if the at least one slide plate comprises a single slide plate or by attaching the slide plates successively in the longitudinal direction LD to the loading dock 116 and by connecting the slide modules to each other, if the at least one slide plates comprises plurality of slide plates. The attached at least one slide plate form a uniform intermediate layer be-tween the loading dock 116 and the mount modules 270, which have been connected by the connection elements 272 to form the uniform upper surface for the chassis 112. The at least one slide plate is configured to enable the mount modules 270 to slide, i.e., to move, with respect to the slide plates.

The loading system 100 further comprises a position light scanner 115 mounted in a front end FE of the chassis 112. The position light scanner 115 comprises laser sensors, e.g., two, three, four, five, or more laser sensors, which are configured to position of the floor 118 of the transport unit 104 to obtain at least floor position information to level the loading ramp 188 vertically with the floor 118 by means of the controller 110.

The loading system 100 further comprises a roller bed 120 mounted on the chassis 112 so that it rests on an upper part of the chassis 112 and can move along the chassis 112. The roller bed 120 is configured to move, to carry the load 102 to be loaded to the transport unit 104, and to drive the load 102 at least forwards FW in a longitudinal direction LD, i.e., in a loading direction. The roller bed 120 is further configured to move backwards BW in the longitudinal direction LD, i.e., in an oppo-site retracting direction, after it has left the load 102 in the transport unit 104.

The roller bed 120 comprises a group of roller bed parts 222, which are arranged as a matrix, which comprises successive rows RO and parallel columns CL, so that each roller bed part 222 belongs to one row RO and one column CL according to the figures. The roller bed parts 222 are configured to establish the roller bed 120.

Each roller bed part 222 comprises rollers 224, which are integrated in a frame 226 of the roller bed part 222 so that the rollers 224 emerge from a lower structure of the frame 226 as well as the rollers 224 project from the upper structure of the frame 226 to establish a low profile of the frame 226 as well as the roller bed 120. The rollers 224 are configured to roll (move) the roller bed 120 together with other rollers 224 of other roller bed parts 222 with respect to the surface below the roller bed 120, e.g., on the chassis 112 along its structure as well as along the floor 118 forwards FW and backwards BW.

The roller bed 120 further comprises load rollers 228, which are integrated in the frame 226 so that load rollers 228 emerge from an upper structure of the frame 226. All load rollers 228 are configured to roll the load 102 forwards with respect to the roller bed 120. A part of the load rollers 228 are also configured to roll the roller bed 120 together with the rollers 224 along a below surface of the load 102 above the roller bed 120 backwards BW when the roller bed 120 is retracted from under the load 102. Another part of the load rollers 228, which are positioned between the forwards-backwards rolling load rollers 228, cannot roll backwards BW, which prevents the load 102 to move accidentally backwards BW on the roller bed 120.

The roller bed 120 comprises the first parallel roller bed parts 222,. i.e., the first row RO in the loading direction, in its front end FE, which are adjacent sideways. The roller bed parts 222 in the first row RO comprise a vertically lowered profile to facilitate the retraction of the roller bed 120 from under the load 102. The front end FE alternatively comprises a uniform single part, which is not presented in the figures, that comprises a vertically lowered profile correspondingly to facilitate the retraction of the roller bed 120 from under the load 102.

The roller bed 120 further comprises a ramp, which is not presented in the figures, mounted at the front end FE of the roller bed 120, which is in the loading direction. The ramp is configured to incline the load 102, at least a last good 106 when the loading system 100 drives the roller bed 120 backwards BW out from under the load 102 (last good 206) in the retracting direction.

The roller bed 120 further comprises a parallel connection mechanism 232, e.g., at least one flexible connection bar, e.g., one, two, three, four, or more flexible connection bars, in a lateral direction AD that is perpendicular to the longitudinal direction LD. The parallel connection mechanism 232 is configured to connect the adjacent parallel roller bed parts 222 in each row RO. The parallel connection mechanism 232 is further configured to connect the adjacent roller bed parts 222 so that the roller bed parts 222 are configured to decline (tilt) by means of the parallel connection mechanism 232 with respect to the chassis 112 and the loading dock 116 in the lateral direction AD to cause the roller bed 120 flexible in the lateral direction AD and an elevation direction ED. The parallel connection mechanism 232 further stabilize the parallel roller bed parts 222 vertically with respect to each other so that the roller bed 120 is sufficiently rigid laterally.

The roller bed 120 further comprises a successive connection mechanism 232 between successive roller bed parts 222, which are adjacent in the longitudinal direction LD. The successive connection mechanism 232 is configured to connect the adjacent successive roller bed parts 222 so that each roller bed part 222 is configured to rotate RT by means of the successive connection mechanism 232 with respect to at least one adjacent successive roller bed part 222 to cause the roller bed 120 flexible in the longitudinal and elevation directions LD, EL.

The loading system 100 further comprises a drive mechanism 234, e.g., two electric motors mounted on both sides of the chassis 112 according to the figures, configured to drive DR the roller bed 120 by means of the rollers 224 forwards FW and backwards BW with respect to other structures of the chassis 112 on the grounds of control commands from the controller 110. The drive mechanism 234 is mounted beside the chassis 112 to enable a fixed mounting of the chassis 112 to the loading dock 116 by means of the mount mechanism 114 so that an elevation of the chassis 112 in the elevation direction ED is permanent with respect to the loading dock 116.

The loading system 100 further comprises a driving actuator 436 for each electric motor of the drive mechanism 234, e.g., a chain driven actuator, mounted in a lateral guide mechanism (slider mechanism) 282, e.g., in guide element 284, beside the roller bed 120. The driving actuator 436 is configured to move the roller bed 120 forwards FW and backwards BW by means of the drive mechanism 234 on the grounds of control commands from the controller 110.

The loading system 100 further comprises a buffer mechanism 238 mounted on the chassis 112 so that the buffer mechanism 238 rests on the upper part of the chassis 112 and it is connected to the chassis 112 in its front end FE. The buffer mechanism 238 is configured to buffer the load 102 when the roller bed 120 is retracted backwards BW from under the load 102. The buffer mechanism 238 allows the roller bed 120 to move through it, to buffer the load 102, and to restrain the load 102, when the loading system 100 drives DR the roller bed 120 backwards BW out from under the load 102.

The buffer mechanism 238 comprises a lifting mechanism with a buffering element (beam) according to the figures on both sides of the chassis 112. The buffer mechanism 238 allows the roller bed 120 to move through it by lifting (pivoting) LF the lifting mechanisms with the buffering elements in an upper position and buffers the load 102 by lowering (pivoting) LO the lifting mechanisms in a lower position above the chassis 112 and buffering the load 102 by the buffering elements when the roller bed 120 is retracted backwards BW from the transport unit 104.

The buffer mechanism 238 alternatively comprises a lifting gate mechanism with a single buffering beam, which is not presented in the figures, instead of the lifting mechanism, whereupon the buffering beam, which is mounted on the lifting gate mechanism, moves vertically in the upwards and downwards between the structures of the lifting gate mechanism and buffers the load 102 by the buffering element correspondingly as the previously explained buffering elements in the lifting mechanism. The buffer mechanism 238 alternatively comprises a lifting mechanism with a buffering beam, which is not presented in the figures and which has been disclosed in application U.S. Ser. No. 18/501,611.

The loading system 100 further comprises a lifting actuator 540 and a buffer actuator 642, e.g., hydraulic, electric belt-driven, rack and pinion-driven, gearwheel-driven, electric cylinder, or pneumatic actuators, mounted in the chassis 112. The lifting actuator 540 is configured to lift LF and to lower LO the lifting mechanism of the buffer mechanism 238 on the grounds of control commands from the controller 110. The buffer actuator 642 is configured to move BU the buffering elements forwards FW and backwards BW with respect to other structures of the buffer mechanism 238 and the chassis 112 on the grounds of control commands from the controller 110.

The loading system 100 further comprises said buffer beam, which is not presented in the figures, mounted on the chassis 112 so that the buffer beam rests on the upper part of the chassis 112 and it is connected to the chassis 112 in its rear end RE. The buffer beam is configured to buffer the load 102 forwards FW by means of the load rollers 228 with respect to the roller bed 120 when the load 102 is formed (preloaded) on the roller bed 120 by means of a forklift (forklift truck) 444 and restrained on the roller bed 120 before the load 202 is driven to the transport unit 104.

The loading system 100 further comprises a beam actuator, which is not presented in the figures, e.g., a hydraulic, electric belt-driven, rack and pinion-driven, gearwheel-driven, electric cylinder, or pneumatic actuator, mounted in the chassis 112. The beam actuator is configured to drive the buffer beam forwards FW and backwards BW with respect to other structures of the chassis 112 on the grounds of control commands from the controller 110.

The loading system 100 further comprises a position light scanner 146 mounted in the front end FE of the chassis 112. The position light scanner 146 comprises laser sensors, e.g., two, three, four, five, or more laser sensors, which are configured to scan at least a position of each side wall 148 of the transport unit 104 to obtain wall position information to position the roller bed 120 laterally by means of the lateral position mechanism 282, if necessary on the grounds of the wall position information, and to guide the roller bed 120 diagonally with respect to the chassis 112 by means of the lateral position mechanism 282, if necessary on the grounds of the wall position information. The obtained wall position information enables the loading system 100 to position and to guide the roller bed 120 so that the loading system 100 can drive the roller bed 120 through the loading door 417 and between the walls 148 inside the transport unit 104.

The loading system 100 alternatively lacks another position light scanner 146 and the previously explained position light scanner 115 is further configured to operate correspondingly as the position light scanner 146, i.e., to scan also the position of each side wall 148 of the transport unit 104 to obtain the wall position information so that the loading system 100 is able to position the roller bed 120 laterally and diagonally.

The loading system 100 further comprises said lateral guide mechanism 282 configured to guide the roller bed 120 with respect to the chassis 112. The lateral guide mechanism 282 comprises at least one guide element 284, e.g. one, two, three, four, or more guide elements, on each side of the roller bed 120.

Each guide element 284 on one side of the roller bed 120 is configured to guide the roller bed 120 laterally and diagonally with respect to the loading dock 116 together with one guide element 284 on other side of the roller bed 120 by means of the mount modules 270.

The loading system 100 further comprises a lateral guide actuator 286, e.g., a hydraulic, electric belt-driven, rack and pinion-driven, gearwheel-driven, electric cylinder, or pneumatic actuator, mounted correspondingly as each guide element 284 beside the chassis 112 to enable the fixed mounting of the chassis 112 so that the elevation of the chassis 112 is permanent with respect to the loading dock 116.

When the mount modules 270 comprises the top plates 276, shafts 378, and lateral rollers 380, the lateral guide actuator 286 is configured to adjust a position of the upper structure, i. e., the top plates 276, of the chassis 112 with the guide elements 284 laterally and diagonally with respect to other structures of the chassis 112 and the loading dock 116, whereupon a position of the roller bed 120, which is on the mount modules 270, is also adjusted correspondingly so that it is possible to drive DR the roller bed 120 through the loading door 417 in the wall structure 119 and between the walls 148 inside the transport unit 104.

When the mount modules 270 comprise the alternative simple structure, the lateral guide actuator 286 is alternatively configured to adjust the position of the upper structure, i. e., the mount modules 270, of the chassis 112 with the guide elements 284 laterally and diagonally with respect to other structures of the chassis 112, e.g., the at least one slide plate, and the loading dock 116 by sliding the mount modules 270 as well as the roller bed 120 on the at least one slide plate, whereupon the position of the roller bed 120, which is on the mount modules 270, is also adjusted correspondingly so that it is possible to drive DR the roller bed 120 through the loading door 417 and between the walls 148 inside the transport unit 104.

Before the one-shot loading operation, when the transport unit 104 has been backed up in front of the front end FE of the loading dock 116 and the loading system 100, the controller 110 adjusts the loading ramp 188 by means of the ramp actuator 490, if the floor position information from the position light scanner 115 indicates a need for matching the loading ramp 188 to the floor 118 of the transport unit 104. The controller 110 then positions the roller bed 120 by means of the mount modules 270, the guide elements 284, and lateral guide actuators 286, if the wall position information from the position light scanner 115, 146 indicates a need for positioning the roller bed 120 laterally and diagonally with respect to the loading dock 116.

The one-shot loading operation is carried by the loading system 100 mutatis mutandis correspondingly as by means of the known one-shot loading system, which has been explained previously in the background, after the controller 110 has carried out necessary previously explained operations, especially the positioning of the roller bed 120 by means of positioned by means of the lateral guide mechanism and actuator 282, 284.

The invention has been now explained with reference to the above exemplary embodiments and its several advantages have been demonstrated. It is clear that the invention is not only restricted to these embodiments, but it comprises all possible embodiments within the scope of the following claims.

1. A loading system (100) for loading a transport unit (104), comprising
a chassis (112),
a roller bed (120) mounted on the chassis, and
a mount mechanism (114) to mount the chassis on a loading dock (116),
which chassis comprises a lateral position mechanism (282) configured to position the roller bed laterally with respect to the loading dock,
which roller bed comprises rollers (224) configured to roll the roller bed forwards and backwards (FW, BW) with respect to the chassis, and
which roller bed is configured to carry a load (102) to be loaded to the transport unit,
wherein the loading system further comprises a drive mechanism (234) that is configured to drive the roller bed forwards and backwards with respect to the chassis and mounted beside the chassis to enable a fixed mounting of the chassis to the loading dock by means of the mount mechanism so that an elevation of the chassis is permanent with respect to the loading dock.

2. The loading system according to claim 1, which roller bed further comprises a group of roller bed parts (222) that are arranged as a matrix, which comprises successive rows (RO) and parallel columns (CL), so that each roller bed part (222) belongs to one row (RO) and one column (CL).

3. The loading system according to claim 2, which roller bed further comprises a successive connection mechanism (232) between successive roller bed parts (222), which are adjacent in a longitudinal direction (LD) and belong to the group of the roller bed parts, and which successive connection mechanism is configured to connect the adjacent successive roller bed parts so that each roller bed part (222) is configured to rotate (RT) by means of the connection mechanism with respect to at least one adjacent successive roller bed part (222) to cause the roller bed flexible in longitudinal and elevation directions (LD, EL).

4. The loading system according to claim 2, which roller bed comprises a parallel connection mechanism (230) configured to connect parallel adjacent roller bed parts (222) so that each roller bed part (222) is configured to decline by means of the parallel connection mechanism with respect to the chassis to cause the roller bed flexible in lateral and elevation directions (AD, EL).

5. The loading system according to claim 1, which lateral position mechanism comprises a lateral guide mechanism (284) configured to guide the roller bed with respect to the chassis by means of a controller (110) and a lateral guide actuator (286).

6. The loading system according to claim 5, wherein the lateral guide mechanism and lateral guide actuator are mounted beside the chassis to enable the fixed mounting of the chassis so that the elevation of the chassis is permanent with respect to the loading dock.

7. The loading system according to claim 5, wherein the lateral guide mechanism comprises at least one guide element (284) on each side of the roller bed and each guide element (284) on one side of the roller bed is configured to guide the roller bed laterally and diagonally with respect to the loading dock together with one guide element (284) on other side of the roller bed.

8. The loading system according to claim 7, wherein the lateral guide actuator comprises at least one hydraulic actuator (284) configured to move the roller bed with respect to the loading dock.

9. The loading system according to claim 1, which chassis comprises mount modules (270) configured to be mounted directly on the loading dock and to be connected successively in a longitudinal direction (LD) by means of a connection element (272) so that the successive mount modules (270) establish a uniform upper surface for the chassis 112.

10. The loading system according to claim 1, which chassis comprises mount modules (270) and each mount module (270) comprises at least one mount plate (374) configured to be mounted on the loading dock, at least one top plate (276) on the mount plate, and lateral rollers (380) between the mount and top plates to move each top plate with respect to the at least one mount plate.

11. The loading system according to claim 10, wherein each top plate (276) comprises shafts (378) mounted on a lower surface of the top plate in a longitudinal direction (LD) and each shaft (378) comprises a lateral roller (380) configured to move along the shaft and to roll to move the top plate with respect to the at least one mount plate.

12. The loading system according to claim 1, which chassis comprises mount modules (270) and each mount module (270) comprises at least one mount plate (374) configured to be installed on the loading dock.

13. The loading system according to claim 12, which mount mechanism comprises at least one slide plate configured to be mounted on the loading dock so that the at least one slide plate is between the loading dock and the mount modules and configured to enable the mount modules to slide with respect to the at least one slide plate.

14. The loading system according to claim 1, which further comprises a controller configured to control an operation of the loading system to operate at least the lateral position and drive mechanisms (234, 282).

15. A loading method for loading a transport unit (104) by means of the loading system (100) according to any of the previous claims, comprising at least following steps of
establishing, by the mount mechanism (114), the permanent elevation of the chassis (112) with respect to the loading dock (116),
mounting, by the mount mechanism, the chassis on the loading dock,
positioning, by the lateral position mechanism (282), the roller bed (120) laterally with respect to the loading dock below the chassis,
driving, by the drive mechanism (234), the roller bed carrying the load (102) forwards (FW) with respect to the chassis when the load is loaded into the transport unit, and
driving, by the drive mechanism, the roller bed backwards (BW) with respect to the chassis when the roller bed is retracted from under the load in the transport unit,
wherein the roller bed comprises the rollers (224) that rolls the roller bed forwards and backwards with respect to the chassis and the drive mechanism is mounted beside the chassis to enable a fixed mounting of the chassis to the loading dock so that the elevation of the chassis is permanent.
